(19) United States
(12) Patent Application Publication
(10) Pub. No.: US 2026/0245960 A1
(43) Pub. Date: Aug. 20, 2026

(54) GEL ELECTROLYTE

(71) Applicants: The Lubrizol Corporation, Wickliffe, OH (US); Nanyang Technological University, Singapore (SG)

(72) Inventors: Sun Yew Wong, Jurong (SG); Ai Qin Thang, Jurong (SG); Ge Yao, Jurong (SG); Qingyu Yan, Singapore (SG)

(21) Appl. No.: 19/304,776

(22) Filed: Aug. 20, 2025

Related U.S. Application Data
(60) Provisional application No. 63/759,349, filed on Feb. 17, 2025.

(51) Int. Cl. H01M 10/0565

(52) U.S. Cl. CPC H01M 10/0565; H01M 2300/0082; H01M 2300/0085

(57) ABSTRACT

The disclosed technology relates to a bi-layer polymer composite for anode-free alkali metal batteries containing a carboxylated-acrylic latex (CMA) and water dispersible steric stabilizer polymer.

### BACKGROUND OF THE INVENTION

The disclosed technology relates to a bi-layer polymer composite for anode-free alkali metal batteries containing a carboxylated-acrylic latex (CMA) and water dispersible steric stabilizer polymer.

To address the growing demand in the energy market, lithium metal batteries (LMBs) are seen as a promising alternative to lithium-ion batteries (LIBs) due to its high energy density. However, the incorporation of lithium (Li) metal in LMBs presents a two-sided dilemma. On one hand, it boasts a substantial theoretical specific capacity of 3,860 mAh/g and a low electrochemical potential of −3.04V vs. the standard hydrogen electrode, resulting in impressive energy density. On the other hand, the use of Li metal raises significant safety concerns, with issues such as undesirable interface reactions and the formation of lithium dendrites that could lead to short circuits and even battery fires. Despite tremendous research efforts aimed at making LMBs viable for market applications, there remains a considerable distance before it can be scaled up effectively.

An alternative approach, the anode-free lithium metal battery (AFLMB), has emerged to tackle the challenges associated with LMBs. AFLMBs share a similar cell configuration with LMBs but eliminate the use of Li metal in the anode. Instead, the Li reserve in AFLMBs is supplemented from the lithiated redox-active cathode material.

Nevertheless, AFLMB is still prone to short circuits. This is because, at charged states, Li is plated on pristine copper (Cu) current collector, transforming back to a LMB. Generally, liquid organic electrolytes and separators used in AFLMB are electrochemically instable at high voltage which hinders the ability to increase its energy density further and intensifies the possibility of short circuits.

The application of gel polymer electrolyte (GPE) is an appealing approach to safely operate Li metal in AFLMB and achieve a higher energy density. GPE encapsulates liquid electrolyte in its solid polymer host, acting as both electrolyte and electronically insulating separator. Due to the polymer host, it is highly flexible, lightweight, processible, and scalable. In addition, the polymer host can also provide strong adhesion to electrodes for better interfacial contact between them, reducing interface impedance and thus reducing polarization during cycling.

Today, poly (methyl methacrylate) (PMMA), poly (vinylidene fluoride-co-hexafluoropropylene (PVDF-HFP), polyvinyl Chloride (PVC), polyacrylonitrile (PAN), polyethylene glycol (PEG), poly (ethylene oxide) (PEO), and poly (vinyl alcohol) (PVA) are commonly used and studied polymer hosts. However, they suffer from either poor lithium-ion (Li⁺) conduction at ambient temperature or incompatible with Li metal anodes. In addition, their high crystallinity (high Tg, rigid polymer chains), and low electrolyte uptake are some common attributors that limit Li⁺ mobility.

Thus, there is a need for an improved gel electrolyte for anode-free alkali metal ion batteries.

### SUMMARY OF THE INVENTION

In one embodiment, the disclosed technology, solves the problem of poor ion conduction and electrolyte stability in anode-free alkali metal ion batteries by employing in said batteries a bi-layer polymer composite of a lithium ion barrier coated with a gel electrolyte containing a carboxylated-acrylic latex (CMA) and water dispersible steric stabilizer polymer. In an embodiment, the CMA can be partially neutralized with a lithium based neutralizing agent.

The Li⁺ barrier can be, for example, an antimony-based barrier.

The bilayer composite can also be employed in a method of operating an anode-free lithium semi-solid-state battery. The method could include preparing the anode-free lithium semi-solid-state battery with the bi-layer polymer composite as discussed, and operating the battery.

### DETAILED DESCRIPTION OF THE INVENTION

Various preferred features and embodiments will be described below by way of non-limiting illustration.

The current technology provides a gel electrolyte for a bilayer polymer composite. The gel electrolytes are contemplated to be used in alternative battery systems such as Li metal anode deigns or graphite-Si anode designs and Lithium sulfur designs as well as anode-free designs. The gel electrolyte contains a combination of a partially neutralized carboxylated-acrylic latex polymer (“CMA”) and a water dispersible steric stabilizer.

The CMA can be the product of emulsion polymerizing a combination of acid containing free radical polymerizable monomer, for example, acrylic acid, itaconic acid, maleic acid, methacrylic acid, etc., and hydrophobic free radical polymerizable monomer, for example, butyl acrylate, HEMA, styrene, ethyl acrylate, etc.

Examples of free radically polymerizable monomers that can be used in the CMA process of the invention include mono vinyl aromatic monomers, alpha-beta ethylenically-unsaturated carboxylic acid ester monomers, unsaturated monomers with carboxylic acid groups, vinyl ester monomers, and various combinations of these. The CMA monomers are preferably selected from the group consisting of esters of acrylic, methacrylic and ethacrylic acid (e.g., those with 4 to 30 carbon atoms) such as n-butyl (meth)acrylate, methyl(meth)acrylate, ethyl(meth)acrylate, 2-ethylhexyl-(meth)acrylate, cycloalkyl(meth)acrylates, such as isobornyl(meth)acrylate and cyclohexyl(meth)acrylate. The vinyl aromatic based monomers include styrene, i.e., styrene or C1-C4-alkyl substituted styrene, for instance alpha-methyl styrene or t-butylstyrene; and vinyltoluene. The diene monomers include dienes such as 1,3-butadiene or isoprene, and mixtures thereof. The CMA monomers can include vinyl esters with 4 to 25 carbon atoms, such as vinyl acetate, vinyl alkanoate or their derivatives or mixtures thereof can be used in the monomer composition. Nitriles, such as acrylonitrile and/or (meth)acrylonitrile, or olefinically unsaturated halides, such as vinyl chloride, vinylidene chloride, and vinyl fluoride can also be used. Preferred vinyl ester monomers include vinyl esters of versatic acids such as the monomers commercialized by Momentive under the trade names VEOVA® 9, 10 and 11.

Unsaturated monomers with acid (e.g., mono or poly-carboxylic acid) functionality, which include monomers of which the acid groups are latent as, for example, in maleic anhydride, are suitably selected from, but not limited to: acrylic acid, methacrylic acid, oligomerized acrylic acids such as beta-carboxyethyl acrylate or its higher analogues (commercially available from Rhodia as Sipomer™ B-CEA), itaconic acid, fumaric acid, maleic acid, citraconic acid, or the anhydrides thereof. Other acid type monomers include styrene p-sulfonic acid, ethylmethacrylate-2-sulfonic acid and 2-acrylamido-2-methylpropane sulfonic acid. An acid bearing monomer could be polymerized as the free acid or as a salt, e.g., the NH4 or alkali metal salts. Monomers with carboxylic acid functionality are preferred over other (non-carboxylic) acid monomers, e.g., sulfonic acid.

Hydrophobic monomers suitable for the preparation of the CMA polymer include but are not limited to one or more of esters of (meth)acrylic acid with alcohols containing 1 to 30 carbon atoms; vinyl esters of aliphatic carboxylic acids containing 1 to 22 carbon atoms; vinyl ethers of alcohols containing 1 to 22 carbon atoms; vinyl aromatics containing 8 to 20 carbon atoms; vinyl halides; vinylidene halides; linear or branched alpha-monoolefins containing 2 to 8 carbon atoms; an associative monomer having a hydrophobic end group containing 8 to 30 carbon atoms, and mixtures thereof.

Other hydrophobic or semi-hydrophobic monomer can be used in the preparation of the CMA polymer. A semi-hydrophobic monomer is similar in structure to an associative monomer, but has a substantially non-hydrophobic end group selected from hydroxyl or a moiety containing 1 to 4 carbon atoms. In one aspect of the invention, the esters of (meth)acrylic acid with alcohols containing 1 to 30 carbon atoms can be represented by the following formula:

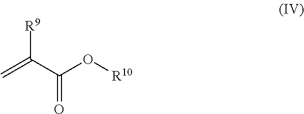

wherein R9 is hydrogen or methyl and R10 is C1 to C22 alkyl. Representative monomers under formula (IV) include but are not limited to methyl (meth)acrylate, ethyl (meth)acrylate, butyl (meth)acrylate, sec-butyl (meth)acrylate, iso-butyl (meth)acrylate, hexyl (meth)acrylate), heptyl (meth)acrylate, octyl (meth)acrylate, 2-ethylhexyl (meth)acrylate, decyl (meth)acrylate, isodecyl (meth)acrylate, lauryl (meth)acrylate, tetradecyl (meth)acrylate, hexadecyl (meth)acrylate, stearyl (meth)acrylate, behenyl (meth)acrylate, and mixtures thereof.

Vinyl esters of aliphatic carboxylic acids containing 1 to 22 carbon atoms can be represented by the following formula:

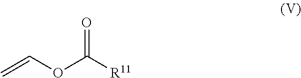

wherein R11 is a C1 to C22 aliphatic group which can be an alkyl or alkenyl. Representative monomers under formula (V) include but are not limited to vinyl acetate, vinyl propionate, vinyl butyrate, vinyl isobutyrate, vinyl valerate, vinyl hexanoate, vinyl 2-methylhexanoate, vinyl 2-ethylhexanoate, vinyl iso-octanoate, vinyl nonanoate, vinyl neodecanoate, vinyl decanoate, vinyl versatate, vinyl laurate, vinyl palmitate, vinyl stearate, and mixtures thereof.

In one aspect, the vinyl ethers of alcohols containing 1 to 22 carbon atoms can be represented by the following formula:

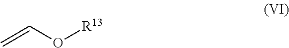

wherein R13 is a C1 to C22 alkyl. Representative monomers of formula (VI) include methyl vinyl ether, ethyl vinyl ether, butyl vinyl ether, isobutyl vinyl ether, 2-ethylhexyl vinyl ether, decyl vinyl ether, lauryl vinyl ether, stearyl vinyl ether, behenyl vinyl ether, and mixtures thereof.

Representative vinyl aromatic monomers include but are not limited to styrene, alpha-methylstyrene, 3-methyl styrene, 4-methyl styrene, 4-propyl styrene, 4-tert-butyl styrene, 4-n-butyl styrene, 4-n-decyl styrene, vinyl naphthalene, and mixtures thereof.

Representative vinyl and vinylidene halides include but are not limited to vinyl chloride and vinylidene chloride, and mixtures thereof.

Representative alpha-olefins include but are not limited to ethylene, propylene, 1-butene, iso-butylene, 1-hexene, and mixtures thereof.

Example emulsions include those prepared with copolymers of styrene and (meth)acrylic esters and acid monomers, such as (meth)acrylic acid and itaconic acid.

The carboxylated-acrylic latex polymer can be partially neutralized with an alkali metal salt. The alkali metal salt can be added to the carboxylated-acrylic latex polymer until a pH of about 4 to 6 has been achieved, or a pH of from about 4.25 to 5.75, or a pH of about 4.5 to 5.5. The alkali metal salt may include for example, LiOH, NaOH, KOH or a combination thereof.

The water based steric stabilizer polymer will (1) contain at least 60 wt. % polyether, and (2) contain acid groups, and (3) a backbone having a weight average molecular weight (Mw) of 1000 or greater, such as 1000 to 50,000, or 1000 to 40,000, or even 1250 to 30,000, or 1500 to 4000 or 5000 as determined by gel permeation chromatography (GPC) based on polystyrene standards.

The water based steric stabilizer polymer includes reaction products of (i) a copolymer, and (ii) a mono-nucleophile (amine or alcohol) terminated polyether derived primarily from ethylene oxide.

The copolymer (i) of the water based steric stabilizer polymer is a copolymer of (1) maleic anhydride, itaconic anhydride, or a combination thereof, and (2) at least one non-acid containing monomer.

Non-acid containing monomers are monomers that do not contain any acid group, such as, for example, a carboxyl group, a sulphonic acid group, a phosphoric acid group, etc. Non-acid containing monomers can include, for example, styrene, ethylene, propylene, butadiene, isobutylene, octadecene, as well as substituted monomers such as vinyl chloride and acrylonitrile. Styrene maleic anhydride is a notable copolymer encompassed by the copolymer of (i), as are copolymers of itaconic anhydride and ethylene.

The molar ratio of non-acid containing monomer, for example, styrene, to anhydride monomer, for example, maleic anhydride or itaconic anhydride, in the copolymer can be, for example 1:1 to 3:1. The molar ratio of non-acid containing monomer, for example, styrene, to anhydride monomer, for example, maleic anhydride or itaconic anhydride, in the copolymer can also be, for example 2:1 or even 3:1.

The copolymer can have an Mn of about 1000 to 10,000 g/mol, or even from about 1500 to 9000 g/mol, or 2000 to 8000 g/mol, or even from about 2500 to about 7000 g/mol, or from about 3000 to about 6000 g/mol as measured by gel permeation chromatography (GPC) based on polystyrene standards.

The copolymer is reacted with a polyether derived primarily from ethylene oxide. The polyether copolymers may be random or block copolymers. In one embodiment, preferably the polyether chain is obtainable from at least 75 mol % ethylene oxide, or from about 75 to 100 mol % ethylene oxide, or 80 to 99 mol %, or 85 to 98 mol % or even 90 to 97 mol % ethylene oxide.

The mono-nucleophile on the polyether can be a mono-amine, an alcohol or a combination thereof

Polyetheramine may be prepared by reacting a mono-alcohol initiator with ethylene oxide only or with a mixture of ethylene oxide and another oxide, such as, for example, propylene oxide or butylene oxide, to form an alcohol-ended polymer chain, followed by conversion of the alcohol to an amine, to prepare the polyetheramine such as those described below. The polyether amine may be commercially available as the Surfonamine® amines from Huntsman Corporation. A specific example of Surfonamine® amines is L100 (ethylene oxide to propylene oxide ratio of 3 to 19) and L-207 (propylene oxide to ethylene oxide mix ratio of 10/33), L-200 (propylene oxide to ethylene oxide mix ratio of (4/41), and L-300 (propylene oxide to ethylene oxide mix ratio of 8/58). The figures in parentheses are approximate repeat units of propylene oxide, and ethylene oxide respectively.

An example mono-alcohol terminated polyether could be, for example, methoxy-polyethylene glycol.

The polyether of (ii) can have a Mn of 500 to 3500 g/mol as measured by gel permeation chromatography (GPC) based on polystyrene standards, or from about 600 to 3000 g/mol, or 700 to 2500 g/mol, or even about 800 to 2000 g/mol.

The mono-nucleophile terminated polyether can be reacted with about 30 to 100 mol % of the anhydride (i.e., maleic of itaconic anhydride), or even from about 35 to about 90 mol % anhydride, or 40 to 80 mol % anhydride, to form amide reaction products, imide reaction products, and combinations thereof.

The weight ratio of the carboxylated-acrylic latex polymer to the water based steric stabilizer polymer can vary between 99.5:0.5 to 90:10. The ratios can also include 99:1 to 91:9, 98.5:1.5 to 92:8. Additionally, the ratio of carboxylated-acrylic latex polymer to the water based steric stabilizer polymer can be at ratios such as 98:2 to 93:7, 97.5:2.5 to 94:6, 97:3 to 95:5, 96.5:3.5 to 96:4.

The gel electrolyte can be prepared as a gel by immersing the combined polymers in at least one nonaqueous solvent along with a dissociable salt.

Examples of non-aqueous solvents include, for example, non-aqueous organic solvents, such as N-methylacetamides, such as dimethylacetamide (DMAc), acetonitrile, acetals, ketals, esters (such as butanone), carbonates, sulfones, sulfites, sulfolanes, aliphatic ethers, acyclic ethers, cyclic ethers, glymes, polyethers, phosphate esters, siloxanes, dioxolanes, N-alkylpyrrolidones, such as N-methylpyrrolidone (NMP), substituted versions of the above, and mixtures thereof. Examples of acyclic ethers that may be used include, but are not limited toWithout limitation: diethyl ether, dipropyl ether, dibutyl ether, Dimethoxymethane (DME), trimethoxymethane, dimethoxyethane, diethoxyethane, 1,2-dimethoxypropane, and 1,3-dimethoxypropane. Examples of cyclic ethers that may be used include, but are not limited to: tetrahydrofuran, Tetrahydropyran (THF), 2-methyltetrahydrofuran, 1,4-bisAlkane, 1,3-Dioxolane (DOL) and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents. Mixtures of the solvents described herein can also be used.

Examples of dissociable salt may include for example, LiOH, LiPF6, LiBF4, LiSbF6, LiAsF6, LiC4F9SO3, LiClO4, LiAlO2, LiAlCl4, LiN(CxF2x+1SO2)(CyF2y+1SO2) (here, x and y are natural numbers), LiTFSI, LiNO3, LiCl, LiI, LiB(C2O4)2 (lithium bis(oxalato) borate; LiBOB), or a combination thereof.

The non-aqueous solvent can be present in the gel electrolyte preparation process at about 10 wt % or more and 85 wt % or less.

A bi-layer composite with the gel electrolyte can be prepared by casting the gel electrolyte into a membrane according to casting processes known in the art. After being cast, one side of the membrane can be coated with a material that acts as a barrier to alkali metal ions to reduce alkali metal ion nucleation. The barrier can be, for example, amorphous antimony.

The gel electrolyte can be included in an anode-free rechargeable battery. The battery can include an anode current collector, a cathode containing an active cation Mn+ (where n=1, 2, or 3), a cathode active material—in either solid form or as a liquid catholyte—and with or without a cathode current collector. The battery can also include a separator disposed or placed between the anode current collector and cathode.

In one embodiment, the active cation Mⁿ⁺ can be a lithium cation (Li+). In another embodiment, the active cation Mⁿ⁺ can be selected from Na+, K+, Mg2+, Ca2+, Zn2+, A13+, or Ag+.

In one embodiment, the concentration of the Mⁿ⁺ salt can be between 1.1-8 mole per liter (M).

In one embodiment, the separator can be a porous polymer material with or without ceramic coatings or composites.

In one embodiment, the separator can be infused with the gel electrolyte.

In one embodiment, the anode current collector can be copper, nickel, iron, or other metals that are stable when in contact with alkali metal and the electrolyte within the operating voltage window of the battery.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### Examples

A PSMA sample was prepared by reacting 13.5 parts of a 7000MW poly(styrene-co-maleic anhydride) ratio 2 styrene:1 maleic anhydride and 27.5 parts of Surfonamine L100 (from Huntsman), diluted into water to make it 40% active in water. A CMA sample was prepared by the emulsion polymerization of 35 wt % butyl acrylate, 0.6 wt % of methacrylic acid, 1.1 wt % of itaconic acid, 21 parts of styrene and 2.4 wt % of n-methyloylacrylamide using redox initiators in water.

Polyvinylidene fluoride, PVDF powder (Solef 5130) was purchased from Solvay S.A. which was used as the binder for cathode. Carbon-coated Lithium Iron Phosphate powder (LiFePO4, LFP), Super P powder (i.e., conductive carbon) and Lithium Metal Chip (0.45 mm thick, 15.6 mm in diameter) were purchased from Dongguan Gelon Lib Co., Ltd. They were used for cathode preparation and used as counter electrode, respectively. N-Methyl-2-pyrrolidone, NMP (Anhydrous, 99.5%) which was used as the solvent for cathode preparation and 1 M LiTFSI in cosolvent of 1,3-dioxolane (DOL) and 1,2-dimethoxyethane (DME) (volume ratio of 1:1) with 2 wt % Lithium nitrate (LiNO3) as electrolyte solution.

A second emulsion polymer, referred to as CMA5, was prepared by neutralizing the CMA sample to a pH of 5 with Lithium Hydroxide (LiOH).

CMA5(A) was prepared by adding 1.5 wt % of PSMA to CMA5.

Composite membranes were prepared from each of the CMA, CMA5 and CMA5(A) using a facile conventional solution casting method, dried at 60° C. for 12 hours. The free-standing membranes were then subjected to magnetron sputtering to achieve a Sb coating.

To achieve the final gelation phase (i.e., to be applied as gel polymer electrolyte), the CMA, CMA5 and CMA5(A) composite membranes were immersed in 1 M LiTFSI in DOL/DME=1:1 (V/V) with 2 wt % LiNO3 electrolyte for 2 hrs in an argon filled glovebox, yielding gel polymer electrolyte (GPE).

Electrochemical performance of the CMA samples was evaluated in a 2032-coin cell configuration.

### Part 1: Fabrication of Bi-layer Gel Polymer Electrolyte

CMA was prepared as supplied. CMA membrane was prepared using a facile conventional solution casting method, dried at 60° C. for 12 hours, then the free-standing membrane was subjected to magnetron sputtering for Sb coating on CMA. CMA5 was prepared by neutralizing CMA to pH 5 with Lithium Hydroxide (LiOH). CMA5(A) was prepared by adding 1.5 wt % of PSMA to CMA5. CMA5 and CMA5(A) composite membranes were made via the same processing methods as CMA. To achieve the final gelation phase (i.e., to be applied as gel polymer electrolyte), CMA, CMA5 and CMA5(A) composite membranes were immersed in 1 M LiTFSI in DOL/DME=1:1 (V/V) with 2 wt % LiNO3 electrolyte for 2 hrs in an argon filled glovebox, yielding gel polymer electrolyte (GPE).

### Part 2: Cell Assembly and Electrochemical Testing

Cathode was prepared by mixing 90% of LFP powder, 5% of Super P and 5% of PVDF using Thinky mixer ARE-310, then coated on a carbon-coated aluminium current collector via a doctor blade. The wet cathode was then dried at 120° C. for 12 hours under vacuum and punched into 12 mm diameter discs. The active mass loading was approximately 5 mg/cm2, 20 μm thick. The bi-layer GPE was then placed on top of the cathode, followed by copper current collector.

One side of the polymer matrix is coated with amorphous Sb (Antimony) to reduce Lithium nucleation barrier, forming a bi-layer polymer composite. The composite is then assembled in a cell. The Sb-coated side faced the bare copper current collector (Cu) impregnated with liquid electrolyte, yielding gel polymer electrolyte (GPE).

A universal mechanical testing machine was used to determine the tensile strength and strain at break data of the three composite membranes.

| | CMA | CMA5 | CMA5(A) |
|---|---|---|---|
| Stress (MPa) | 1.44 | 2.01 | 2.61 |
| Strain (%) | 365.21 | 617.87 | 1103.66 |

An electrochemical impedance spectroscopy (EIS) test was performed with the electrochemical workstation Autolab Pgstat (Metrohm, Switzerland) to determine ionic conductivities of the GPE.

Electrolyte uptake test was conducted to screen the viability and compatibility of the polymer. This can provide visibility on the solubility of the polymer when soaked in an electrolyte for an extended period. This value was obtained by calculating the weight difference of the polymer film measured before and after it was being soaked in 1 M LiTFSI in DOL/DME=1:1 (V/V) with 2 wt % LiNO3 electrolyte at 25° C. for 30 minutes. Electrolyte Uptake % is defined as 100*(Final weight−Initial weight)/initial weight.

Electrochemical performance was evaluated in 2032-coin cell configuration. Coin cells were assembled in an argon filled glovebox with <0.1 ppm of moisture and oxygen. Electrochemical impedance spectroscopy (EIS) test was performed with the electrochemical workstation Autolab Pgstat (Metrohm, Switzerland) to determine ionic conductivities of GPE.

A composite membrane (i.e., bi-layer GPE) was sandwiched between two SS (i.e., SS/composite membrane/SS cells) then impregnated with liquid electrolyte to determine the ionic conductivity (a) of the separators by inputting the measured bulk resistances (Rb), via an alternating current (AC) impedance analyser in combination with the electrochemical workstation Autolab Pgstat 302 (Metrohm, Switzerland) in the frequency range from 0.1 Hz to 106 Hz with a 5 mV of scan amplitude, thickness of the self-fabricated composite membrane (L) and the contact area (A) between composite membrane and SS.

$$Electrolyte Uptake$$

$$Electrolyte uptake , \% = \frac{Final weight - Initial weight}{Initial weight} \times 100 \% \qquad Equation 1$$

Electrolyte uptake test was conducted to screen the viability and compatibility of the polymer to be used for such application. This can provide visibility on the solubility of the polymer when it was soaked in an electrolyte for an extended period. This value was obtained by calculating the weight difference of the polymer (film) measured before and after it was being soaked in 1 M LiTFSI in DOL/DME=1:1 (V/V) with 2 wt % LiNO3 electrolyte at 25° C. for 30 minutes, i.e., Equation (1). Values are shown in table 1.

$$Ionic Conductivity$$

$$σ = \frac{L}{A \times {R}_{b}} \qquad Equation 2$$

Electrochemical performance was evaluated in 2032-coin cell configuration. Coin cells were assembled in an argon filled glovebox with <0.1 ppm of moisture and oxygen. Electrochemical impedance spectroscopy (EIS) test was performed with the electrochemical workstation Autolab Pgstat (Metrohm, Switzerland) to determine ionic conductivities of GPE.

A composite membrane (i.e., bi-layer GPE) was sandwiched between two SS (i.e., SS/composite membrane/SS cells) then impregnated with liquid electrolyte to determine the ionic conductivity (a) of the separators by inputting the measured bulk resistances (Rb), via an alternating current (AC) impedance analyser in combination with the electrochemical workstation Autolab Pgstat 302 (Metrohm, Switzerland) in the frequency range from 0.1 Hz to 106 Hz with a 5 mV of scan amplitude, thickness of the self-fabricated composite membrane (L) and the contact area (A) between composite membrane and SS in Equation (2). Values are shown in Table 1.

TABLE 1

| | CMA | CMA5 | CMA5(A) |
|---|---|---|---|
| Electrolyte Uptake | 144 | 183 | 201 |
| Ion Conductivity | 0.121 | 0.158 | 0.166 |

$$Li + transference number ( {t}_{{Li}^{+}} )$$

$${t}_{{Li}^{+}} = \frac{{I}_{S} ( Δ V - {I}_{0} {R}_{0} )}{{I}_{0} ( Δ V - {I}_{S} {R}_{S} )} \\ {I}_{0} and {I}_{S} ( mA ) ; {R}_{0} and {R}_{S} ( Ω ) \qquad Equation 3$$

Electrochemical impedance spectroscopy (EIS) was also conducted on symmetrical Li/GPE/Li cells to evaluate the interfacial resistance of the GPE during storage. Li⁺ transference number (LITN, tLi+) was determined by measuring both AC impedance and direct current (DC) polarization of Li symmetrical (Li/GPE/Li) cells. DC polarization was conducted at a constant potential difference (ΔV) of 10 mV. Bruce-Vincent-Evans equation (i.e., Equation (3)) was used to calculate tLi+.

Wherein I0 and Is represent the initial and steady-state currents of the polarization currents (chronoamperometry); while R0 and RS represent the initial and steady-state interfacial resistances. Results are shown in Table 2.

TABLE 2

| | CMA | CMA5 | CMA5(A) |
|---|---|---|---|
| Li ion transference | 0.705 | 0.790 | 0.802 |
| number t_{Li}_{⁺} | | | |

Galvanostatic charge/discharge performance and rate performance of LFP/GPE/Li cells were evaluated using Neware multichannel battery test system. 80 μL of electrolyte was used in each cell. These cells were first aged for 12 hours and precycled at 0.1C for 2 cycles (2.7 V to 4 V). To evaluate the cycling performance, these cells were cycled at a constant charge/discharge of 0.3C from 2.7 V to 4 V for 110 cycles.

To evaluate the cycling performance, these cells were cycled at a constant charge/discharge of 0.3C from 2.7 V to 4.0 V for 110 cycles.

After 110 cycles at 0.3C-rate, the capacity retention of cells containing CMA, CMA5 and CMA5(A) are 20.4%, 86.6%, and 91.6%, respectively. Results are shown in Table 3.

TABLE 3

| | CMA | CMA5 | CMA5(A) |
|---|---|---|---|
| | Discharge Capacity | Discharge Capacity | Discharge Capacity |
| Cycle | (mAh/g) | (mAh/g) | (mAh/g) |
| 10 | 152.25 | 152.78 | 156.78 |
| 20 | 152.08 | 152.15 | 156.70 |
| 30 | 152.01 | 152.03 | 156.65 |
| 40 | 151.93 | 151.96 | 156.57 |
| 50 | 151.51 | 151.70 | 156.33 |
| 60 | 151.08 | 151.37 | 156.07 |
| 70 | 150.04 | 151.19 | 155.51 |
| 80 | 143.73 | 150.64 | 154.81 |
| 90 | 72.74 | 149.70 | 153.75 |
| 100 | 47.03 | 146.37 | 151.99 |
| 110 | 31.14 | 132.44 | 143.63 |

Each of the documents referred to above is incorporated herein by reference. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

What is claimed is:

1. A bi-layer polymer composite comprising a) a gel electrolyte comprising a carboxylated-acrylic latex polymer and a water dispersible steric stabilizer polymer, and b) a lithium ion barrier, wherein the gel electrolyte of a) is coated onto the lithium ion barrier b).
